(19) United States
(12) Patent Application Publication
(10) Pub. No.: US 2024/0273962 A1
(43) Pub. Date: Aug. 15, 2024

(54) MEDIUM PROCESSING DEVICE AND MEDIUM TRANSACTION DEVICE

(71) Applicant: Oki Electric Industry Co., Ltd., Tokyo (JP)

(72) Inventors: Takahiro SAKURAI, Tokyo (JP); Katsuyoshi TOMIZAWA, Tokyo (JP)

(73) Assignee: Oki Electric Industry Co., Ltd., Tokyo (JP)

(21) Appl. No.: 18/566,920

(22) PCT Filed: May 18, 2022
(86) PCT No.: PCT/JP2022/020719

§ 371 Date: Dec. 4, 2023

(30) Foreign Application Priority Data
Jun. 15, 2021 (JP) 2021-099779

(51) Int. Cl. G07D 11/18; G07D 11/237; G07D 11/26

(52) U.S. Cl. CPC G07D 11/18; G07D 11/237; G07D 11/26; G07D 2211/00

(57) ABSTRACT

Banknote device having a take-in/discharge section driven by a first motor to feed out banknotes from a pay-in section; a first conveyance section connected to the pay-in section and driven by a second motor driven independently of the first so as to convey banknotes; a classification section for the first conveyance section, that classifies conveyed banknotes; a rearside conveyance section connected to the first conveyance section, driven by a third motor for driving independently of the first and second, to convey the banknotes; a storage box connected to the rearside conveyance section, that stores normal banknotes; and a banknote control section that, upon detecting abnormal pay-in rejects or jammed banknotes in the first conveyance section, stops driving the first motor to stop the take-in/discharge section and driving of the second motor to stop the first conveyance section, and conveys normal banknotes in the rearside conveyance section to the storage box.

### TECHNICAL FIELD

The present disclosure relates to a medium processing device and a medium transaction device applicable to, for example, an automated teller machine (ATM) having a paper leaf-shaped medium such as a banknote introduced therein and performing a desired transaction.

### BACKGROUND ART

Hitherto, automated teller machines employed in financial institutions and the like perform various transactions according to the content of a transaction with a customer, for example performing a pay-in transaction with a customer to pay in cash such as banknotes or coins, or a pay-out transaction to pay out cash to the customer. One type of automated teller machine is referred to as a so-called re-cycling type (or recirculating type) in which banknotes paid in from a customer in a given transaction are reused next time in a subsequent transaction to be paid out to another customer.

Some re-cycling type automated teller machines are installed, for example, with a banknote pay-in/pay-out device that performs processing relating to paying in and paying out banknotes. A proposal for such a banknote pay-in/pay-out device includes, for example, a pay-in/pay-out section to exchange banknotes with a customer, a conveyance section to convey banknotes, a classification section to classify introduced banknotes for denomination and authenticity, a temporary holding section to temporarily hold introduced banknotes, banknote storage boxes to store banknotes for each denomination, and a reject box to store banknotes that are unsuitable for reuse (see, for example, Japanese Patent Application Laid-Open (JP-A) No. 2015-201163 (Patent Document 1)).

Moreover in a pay-in transaction in a banknote pay-in/pay-out device, a pay-in transaction can be speeded up and operational efficiency improved by performing direct pay-in which, prior to confirming pay in of banknotes that have been introduced to a pay-in/pay-out section and classified in a classification section, the banknotes are directly conveyed from the pay-in/pay-out section to a banknote storage box using a conveyance section and stored therein without being temporarily held in a temporary holding section, enabling many banknotes to be paid in by a single transaction without being limited by an upper limit of the number of banknotes held in the temporary holding section.

### SUMMARY OF INVENTION

### Technical Problem

When direct pay-in is performed in banknote pay-in/pay-out device such as that described in Patent Document 1, in cases in which a banknote being conveyed in the conveyance section is a reject banknote, conceivably the conveyance of the banknote in the conveyance section might be stopped, and all of the banknotes present in the conveyance section returned to the pay-in/pay-out section. Moreover, in cases in which a banknote being conveyed in the conveyance section has become a jammed banknote when direct pay-in is being performed in such a banknote pay-in/pay-out device, the conveyance of the banknote in the conveyance section is stopped. However, in such cases this results in normal banknotes mixing with the reject banknote or jammed banknote that is a abnormal banknote in the conveyance section. There is accordingly a possibility of the normal banknote being returned to the customer, there being a mistake in count result, and reliability not being maintained.

In consideration of the above circumstances, the present disclosure proposes a medium processing device and a medium transaction device able to improved reliability.

### Solution to Problem

In order to address such issues, a medium processing device of the present disclosure is configured so as to be provided with a pay-in section into which a medium is introduced, a feed-out section driven by a first drive source so as to feed out the medium from the pay-in section, a first conveyance section that is connected to the pay-in section and driven by a second drive source driven independently of the first drive source so as to convey the medium, a classification section that is provided to the first conveyance section and classifies the conveyed medium, a second conveyance section that is connected to the first conveyance section and driven by a third drive source for driving independently of the first drive source and the second drive source so as to convey the medium, a storage box that is connected to the second conveyance section and stores the medium, and a control section that, when determined that an abnormal medium is present in the first conveyance section, stops driving of the first drive source so as to stop the feed-out section and also stops driving of the second drive source so as to stop the first conveyance section and convey the medium present in the second conveyance section to the storage box and store the medium therein.

A medium transaction device of the present disclosure is configured so as to be provided with a pay-in section into which a paper leaf-shaped medium for transaction with a user is introduced, a feed-out section that is driven by a first drive source so as to feed out the medium from the pay-in section, a first conveyance section that is connected to the pay-in section and driven by a second drive source driven independently of the first drive source so as to convey the medium, a classification section that is provided to the first conveyance section and classifies the conveyed medium, a second conveyance section that is connected to the first conveyance section and driven by a third drive source for driving independently of the first drive source and the second drive source so as to convey the medium, a storage box that is connected to the second conveyance section and stores the medium, and a control section that, when determined that an abnormal medium is present in the first conveyance section, stops driving of the first drive source so as to stop the feed-out section and also stops driving of the second drive source so as to stop the first conveyance section and convey the medium present in the second conveyance section to the storage box and store the medium therein.

In the present disclosure, normal banknotes are not caused to linger in the second conveyance section, enabling normal banknotes and an abnormal banknote to be prevented from mixing in the conveyance section.

The present disclosure does not cause normal banknotes to linger in the second conveyance section, enables mixing of the normal banknotes and an abnormal banknote in the conveyance section to be prevented, and the present disclosure is accordingly able to implement a medium processing device and a medium transaction device able to improve reliability.

### BRIEF DESCRIPTION OF DRAWINGS

FIG. 1 is a perspective view illustrating an external configuration of an automated teller machine.

FIG. 2 is a left side view illustrating a configuration of a banknote pay-in/pay-out device.

FIG. 3 is a left side view illustrating a configuration of a conveyance section.

FIG. 4 is a flowchart illustrating a pay-in processing routine.

FIG. 5 is a left side view illustrating conveyance paths of normal banknotes.

FIG. 6 is a left side view illustrating a conveyance path (1) when a pay-in reject banknote occurs.

FIG. 7 is a left side view illustrating a conveyance path (2) when a pay-in reject banknote occurs.

FIG. 8 is a left side view illustrating a conveyance path (3) when a pay-in reject banknote occurs.

FIG. 9 is a left side view illustrating a conveyance path (1) when a jammed banknote occurs.

FIG. 10 is a left side view illustrating a conveyance path (2) when a jammed banknote occurs.

FIG. 11 is a drawing illustrating a configuration of a jam removal guidance screen.

### DESCRIPTION OF EMBODIMENTS

Description follows regarding an embodiment to implement the invention (hereafter referred to as exemplary embodiment), with reference to the drawings.

### 1. Overall Configuration of Automated Teller Machine

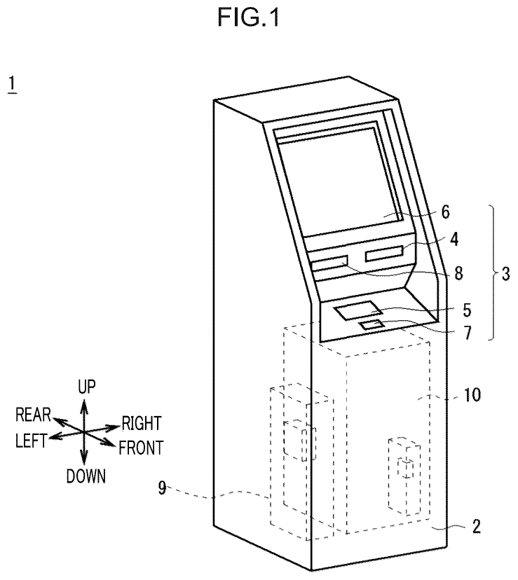

As illustrated in FIG. 1, an automated teller machine 1 configured around a box shaped case 2 is installed in a financial institution or the like for example, and performs transactions related to cash such as pay-in transactions and pay-out transactions with a customer. The case 2 is provided with a customer interface section 3 at a location where inserting banknotes and operation using a touch panel etc. is easy in a state in which a customer faces the front side of the case 2.

The customer interface section 3 is provided with a card insertion/removal port 4, a pay-in/pay-out port 5, an operation and display section 6, a ten-key 7, and a receipt issue port 8. The customer interface section 3 directly handles cash and passbook interactions with the customer, and notifies transaction-related information and receives operation instructions and the like. The card insertion/removal port 4 is a part where various cards such as cash cards are inserted or dispensed. A card processing section (non-illustrated) is provided at a far side of the card insertion/removal port 4 for performing reading of an account number or the like magnetically recorded on the various cards. The pay-in/pay-out port 5 is a part into which the customer introduces banknotes for paying in, and from which banknotes for dispensing to the customer are paid out. The pay-in/pay-out port 5 is opened or closed by driving a shutter. Banknotes are, for example, configured by rectangular shaped paper. The operation and display section 6 is configured by a liquid crystal display (LCD) for displaying an operation screen during a transaction, integrated together with a touch panel for selecting a type of transaction and entering a PIN number, a transaction amount, and the like. The ten-key 7 is physical keys for receiving entry of numbers from “0” to “9” etc., and is employed during an operation to enter the PIN number, transaction amount, and the like. The receipt issue port 8 is a part that issues a receipt printed with transaction details and the like at the end of transaction processing. A receipt processor (not illustrated in the drawings) that prints transaction content and the like on a receipt is provided behind the receipt issue port 8.

A main control section 9 that performs general control of the overall automated teller machine 1, a banknote pay-in/pay-out device 10 that performs various processing relating to banknotes, and the like are provided inside the case 2. The main control section 9 is configured around a Central Processing Unit (CPU), not illustrated in the drawings. The main control section 9 reads and executes specific programs from a non-illustrated ROM, flash memory, or the like to perform various processing such as pay-in processing and pay-out processing. The main control section 9 is provided with an internal storage section including Random Access Memory (RAM), a hard disk drive, flash memory, or the like. The storage section is stored with various information.

In the following explanation, a side of the automated teller machine 1 facing a customer is defined as being a front side, and an opposite side thereto is defined as being a rear side. Left and right as seen by a customer facing the front side are defined as being a left side and a right side, and furthermore an upper side and a lower side are defined thereby.

### 2. Banknote Pay-In/Pay-Out Device Configuration

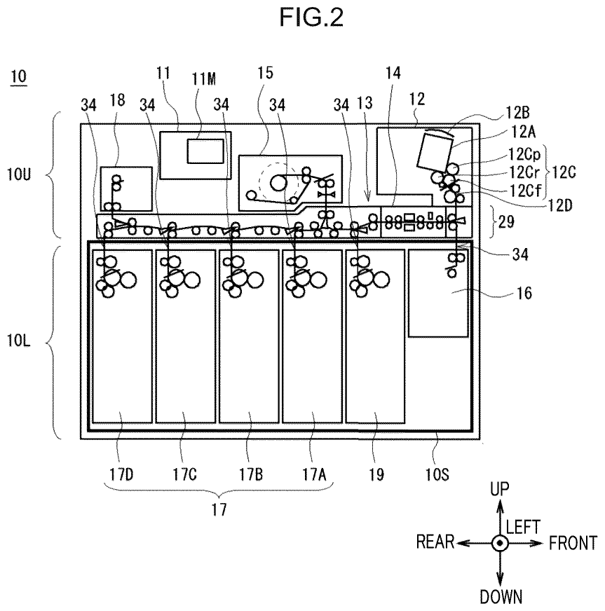

As illustrated in side view in FIG. 2, plural sections that perform various processing relating to banknotes are incorporated inside the banknote pay-in/pay-out device 10. The banknote pay-in/pay-out device 10 is configured split broadly into an upper section block 10U occupying a portion further to the upper side than an up-down direction approximate center, and a lower section block 10L closing up a portion at a lower side thereof.

### 2-1. Upper Section Block Configuration

The upper section block 10U is provided with a banknote control section 11 that performs general overall control, a pay-in/pay-out section 12 that exchanges banknotes with a customer, a straight line conveyance section 29 that conveys banknotes to the respective sections, a classification section 14 that classifies banknotes, a temporary holding section 15 that temporarily stores banknotes, and a counterfeit note box 18 that stores banknotes that have been classified as counterfeit notes.

Similarly to the main control section 9, the banknote control section 11 is configured around a non-illustrated CPU, and reads and executes specific programs from non-illustrated ROM, flash memory, or the like so as to perform various processing such as processing to decide the conveyance destination of a banknote, and processing to control operation of the respective sections. The banknote control section 11 is provided with an internal storage section 11M including RAM, flash memory, or the like. The storage section 11M is stored with various information.

The pay-in/pay-out section 12 is positioned at a front upper portion inside the upper section block 10U. The pay-in/pay-out section 12 includes an internal receptacle 12A that houses banknotes paid in by a customer, and banknotes to be paid out to a customer, and can be opened and closed by a shutter 12B above the pay-in/pay-out section 12. Plural banknotes are stacked inside the receptacle 12A in a state with their sheet faces facing the front-rear direction, namely housed in a state arranged in a line along the front-rear direction.

A take-in/discharge section 12C and a pay-in/pay-out conveyance section 12D are provided at the lower front of the pay-in/pay-out section 12. The take-in/discharge section 12C is configured by a pick-up roller 12Cp, a paper feed roller 12Cf, and a separation roller 12Cr. The pick-up roller 12Cp is positioned at a front side of a take-in/discharge port (omitted in the drawings) for connecting to the inside of the receptacle 12A and to the pay-in/pay-out conveyance section 12D, and is able to rotate. The paper feed roller 12Cf and the separation roller 12Cr that are installed as a pair in a state of contact positioned at a front side and a rear side below of the pick-up roller 12Cp and, for example, feed out banknotes one at a time to the pay-in/pay-out conveyance section 12D positioned downstream thereof when plural banknotes have been withdrawn at the same time. Under the control of the banknote control section 11, the take-in/discharge section 12C operates while switching between two types of operation mode, namely a take-in mode and a discharge mode. Namely, in the take-in mode, the take-in/discharge section 12C rotates the pick-up roller 12Cp and the paper feed roller 12Cf counterclockwise as viewed in FIG. 2. Banknotes inside the receptacle 12A are thereby separated from each other and fed out one at a time downward at each specific time interval, and transferred to the straight line conveyance section 29 via the pay-in/pay-out conveyance section 12D. The straight line conveyance section 29 thereby conveys separated banknotes with a specific conveyance spacing between banknotes. In the discharge mode, the take-in/discharge section 12C discharges banknotes that have been transferred from the straight line conveyance section 29 into the receptacle 12A, via the pay-in/pay-out conveyance section 12D, by rotating the pick-up roller 12Cp and the paper feed roller 12Cf clockwise as viewed in FIG. 2.

The counterfeit note box 18 is provided at a position directly above and adjacent to the straight line conveyance section 29 in the vicinity of a rear end at the inside of the upper section block 10U, and includes an internal space to store banknotes therein. The counterfeit note box 18 internally stores banknotes arriving thereat conveyed by the straight line conveyance section 29 after being determined to be counterfeit banknotes (referred to below as counterfeit notes) by the classification section 14 and the banknote control section 11, described later.

### 2-2. Conveyance Section Configuration

The straight line conveyance section 29 is disposed at a lower edge portion of the interior of the upper section block 10U, in other words above the lower section block 10L, described later. Namely, the straight line conveyance section 29 is positioned so as to cut across in the front-rear direction substantially at the up-down direction center of the overall banknote pay-in/pay-out device 10, and has an overall shape that is thin in the up-down direction, and long and thin in the front-rear direction. Several rotating rollers, guides that guide the banknotes, and the like are disposed as appropriate inside the straight line conveyance section 29, thereby forming a straight line shaped conveyance path that conveys banknotes substantially along the front-rear direction with the direction of their short edges as the progression direction.

Plural switching sections are disposed inside the straight line conveyance section 29. Each switching section is configured by a member referred to as a “blade” (illustrated by triangular shapes in the drawings) and plural rollers disposed at a periphery thereof. The blades are long in the left-right direction, are formed in wedge shapes as viewed along the left-right direction, and are rotated to change their inclination direction, thereby switching banknote conveyance directions two ways. The respective rollers are disposed so as to face each other across a banknote conveyance path. Under the control of the banknote control section 11, the switching sections change the inclination directions of their respective blades and rotate the respective rollers in specific rotation directions according to the conveyance destination of each banknote. The banknote conveyance direction is thereby switched so as to convey the banknote toward the desired conveyance destination.

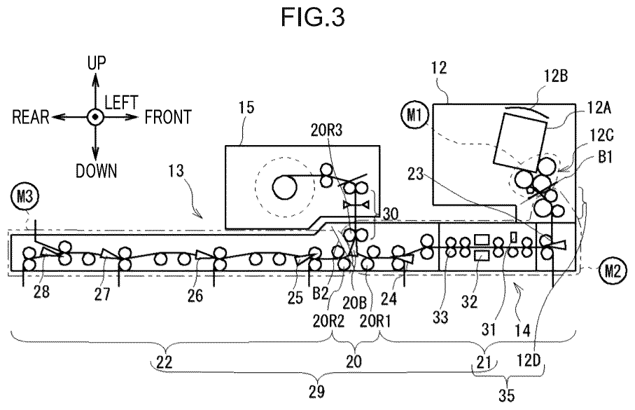

As illustrated in enlarged view in FIG. 3, the straight line conveyance section 29 is configured broadly split into a front side conveyance section 21 on the front side, a rear side conveyance section 22 on the rear side, and a temporary holding switching section 20 connecting the two together. The pay-in/pay-out conveyance section 12D and the front side conveyance section 21 will be referred to collectively below as a first conveyance section 35.

The temporary holding switching section 20 is configured by a centrally positioned blade 20B, and rollers 20R1, 20R2, and 20R3 respectively positioned at the front side, the rear side, and the upper side of the blade 20B. Similarly to the blades of the respective switching sections described above, the blade 20B rotates to change its angle of inclination. However, unlike the other switching sections, the blade 20B switches the banknote conveyance direction three ways, and is what is referred to as a three-way blade. A third conveyance section 30 is provided between the temporary holding switching section 20 and the temporary holding section 15.

Specifically, the temporary holding switching section 20 switches between forming a conveyance path linking the third conveyance section 30 at the upper side and the front side conveyance section 21 at the front side together, forming a conveyance path linking the third conveyance section 30 at the upper side and the rear side conveyance section 22 at the rear side together, or forming a conveyance path linking the front side conveyance section 21 at the front side and the rear side conveyance section 22 at the rear side together.

The temporary holding section 15 employs what is referred to as a tape escrow method, and stores banknotes by wrapping the banknotes against a circumferential side face of a circular cylinder shaped drum together with a tape, and feeds out the banknotes by peeling the tape away from the circumferential side face.

The pay-in/pay-out conveyance section 12D, the straight line conveyance section 29 (the front side conveyance section 21, the temporary holding switching section 20, and the rear side conveyance section 22) together with the third conveyance section 30 will also be called conveyance section 13. Run monitoring sensors (omitted in the drawings) are disposed at respective locations on the conveyance section 13. The run monitoring sensors are configured similarly to optical sensors provided to the run sensor 33 (described later) of the classification section 14, detect a banknote conveyance state, and send detection results thereof to the banknote control section 11. In response thereto, the banknote control section 11 ascertains whether or not there is a spacing or skew between the banknotes being conveyed, an overlap of banknotes, a length orientated along the conveyance direction, an occurrence of a jam, and the like.

A reject switching section 23, the classification section 14 (described in detail later), and a first switching section 24 are disposed in series inside the front side conveyance section 21 in this sequence from the front, with these sections connected together by short conveyance paths that are relatively short and forming an overall straight line shaped conveyance path along the front-rear direction.

The reject switching section 23 changes the blade inclination direction so as to switch the banknote conveyance path two ways, cither forming a conveyance path linking the pay-in/pay-out section 12 at the upper side and the classification section 14 at the rear side together, or forming a conveyance path linking the classification section 14 at the rear side and a reject box 16 at the lower side together. Similarly to the reject switching section 23, the first switching section 24 is configured so as to switch the banknote conveyance path two ways and either forms a conveyance path linking a short conveyance path at the rear side and a recovery box 19 at the lower side together, or forms a conveyance path linking the short conveyance path at the rear side and a short conveyance path at the front side together.

A second switching section 25, a third switching section 26, a fourth switching section 27, and a counterfeit note switching section 28 are disposed in series inside the rear side conveyance section 22 in this sequence from the front. Similarly to in the front side conveyance section 21, these sections are respectively connected together by short conveyance paths that are relatively short, thereby forming an overall straight line shaped conveyance path along the front-rear direction.

The second switching section 25, the third switching section 26, and the fourth switching section 27 are each formed so as to be substantially front-rear symmetrical to the first switching section 24, and are each configured so as to switch the banknote conveyance path two ways. Namely, the second switching section 25, the third switching section 26, and the fourth switching section 27 switch between forming conveyance paths linking short conveyance paths on the respective front sides thereof and banknote storage boxes 17A, 17B, or 17C on the respective lower sides thereof together, or forming conveyance paths linking the short conveyance paths on the respective front sides thereof and short conveyance paths on the respective rear sides thereof together.

The counterfeit note switching section 28 is formed so as to be substantially up-down symmetrical to the second switching section 25, the third switching section 26, and the fourth switching section 27, and switches between forming a conveyance path linking a short conveyance path on the front side thereof and the counterfeit note box 18 on the upper side thereof together, or forming a conveyance path linking the short conveyance path on the front side thereof and a banknote storage box 17D together through a short conveyance path on the rear side thereof.

### 2-3 Drive Source Configuration

Each of the rollers of the take-in/discharge section 12C, each of the rollers of the pay-in/pay-out conveyance section 12D, each of the rollers of the front side conveyance section 21, each of the rollers of the rear side conveyance section 22, and each of the rollers configuring the temporary holding switching section 20 have drive force respectively transmitted thereto from dedicated motors M1, M2, and M3 that are controlled independently in each region demarcated by drive boundary lines B1 and B2 in FIG. 3. These motors M1, M2, and M3 are attached in the vicinity of the rollers etc. to which respective drive force is transmitted, namely, are respectively attached inside the take-in/discharge section 12C, the front side conveyance section 21, and the rear side conveyance section 22. The third conveyance section 30 conveys banknotes by the rollers 20R3 of the temporary holding switching section 20 being rotated.

Namely, the motor M1 drives the pick-up roller 12Cp, the paper feed roller 12Cf, and the separation roller 12Cr (FIG. 2) of the take-in/discharge section 12C. The motor M2 drives each of the rollers of the pay-in/pay-out conveyance section 12D, each of the rollers of the front side conveyance section 21, the rollers 20R1 of the temporary holding switching section 20, and the rollers 20R3 of the temporary holding switching section 20. Furthermore, the motor M3 drives each of the rollers of the rear side conveyance section 22, and the rollers 20R2 of the temporary holding switching section 20.

Thus in the take-in/discharge section 12C and the conveyance section 13, due to the motors M1, M2, and M3 being respectively independently controlled by the banknote control section 11, the take-in/discharge section 12C, a portion between a front side of the blade 20B of the temporary holding switching section 20 and the take-in/discharge section 12C and the third conveyance section 30, and a portion at a rear side of the blade 20B of the temporary holding switching section 20, are each driven independently, thereby enabling banknotes to be conveyed independently from each other.

The motors M1, M2 and M3 are, for example, stepping motors or direct current (DC) brushless motors or the like so as to enable fine rotation angle control by the banknote control section 11. The banknote control section 11 thereby ascertains accurate rotation rates, rotation angles, and the like for the motors M1, M2 and M3, and by performing arithmetic processing thereon, such as multiplying these by specific coefficients, the banknote control section 11 also ascertains the rotation rates and rotation angles of the respective rollers, namely the conveyance distances of banknotes.

The straight line conveyance section 29 accordingly forms a straight line shaped conveyance path along the front-rear direction, which is an array direction along which the banknote storage boxes 17 are arrayed, configured by the front side conveyance section 21, the temporary holding switching section 20, and the rear side conveyance section 22, and banknotes are conveyed along the conveyance path substantially in the front-rear direction, with the conveyance path thereof being switched by the plural switching sections.

### 2-4. Classification Section Configuration

Plural types of sensor are incorporated inside the classification section 14 to ascertain the denomination, authenticity, condition (whether or not damage is present), and conveyance state of conveyed banknotes, with the ascertained results thereof sent to the banknote control section 11. Note that the conveyance state indicates a state such as, for example, whether or not a banknote is inclined with respect to the conveyance direction (namely, whether or not a skew had occurred), whether or not the spacing between conveyed banknotes is appropriate, and whether or not plural banknotes are overlapping (namely, whether or not double feeding or chains have occurred).

Specifically, a conveyance path is formed inside the classification section 14 so as to link a front transfer port on a front side and a rear transfer port on a rear side together in a straight line shape along the front-rear direction, and an authenticity sensor 31, an image sensor 32, and a run sensor 33 are disposed along this conveyance path in this sequence from the front side.

The authenticity sensor 31 is, for example, a magnetic sensor, and detects the magnetism of banknotes conveyed on the conveyance path, and sends a detection result to the banknote control section 11. Based on the detection result supplied from the authenticity sensor 31, the banknote control section 11 determines whether a banknote is genuine (what is referred to as a genuine note) or counterfeit (what is referred to as a counterfeit note).

The image sensor 32 includes two individual imaging elements facing each other across the conveyance path. The imaging elements image the two faces of banknotes conveyed on the conveyance path to generate image data, and send the image data to the banknote control section 11. The banknote control section 11 compares pre-stored image data for each denomination against the supplied image data to ascertain the denomination, level of damage, and the like of each banknote, and also to ascertain the individual serial number inscribed on each banknote.

The run sensor 33 includes, for example, a thickness sensor and optical sensor. The thickness sensor detects the thickness of a conveyed banknote, and supplies a detection result thereof to the banknote control section 11. Based on the detection result supplied from the thickness sensor, the banknote control section 11 determines whether the thickness of the conveyed banknote corresponds to that of a single banknote, or corresponds to that of two or more banknotes.

The optical sensor includes, for example, a light emitting element that emits light, and a light receiving element that receives the light, disposed so as to face each other across the conveyance path, with the optical sensor detecting whether or not light is being blocked by a banknote conveyed on the conveyance path and sending detection results to the banknote control section 11. Plural of the optical sensors are disposed in the run sensor 33 along the left-right direction, namely along a direction intersecting the front-rear direction, this being the conveyance direction. Based on the detection results supplied from the respective optical sensors and their changes over time and the like, the banknote control section 11 ascertains the lengths along the conveyance direction of banknotes being conveyed, the spacing between banknotes along the conveyance direction, and the inclination of banknotes with respect to the conveyance direction.

Namely, the run sensor 33 supplies the respective detection results of the thickness sensor and each of the optical sensors to the banknote control section 11, and causes the banknote control section 11 to ascertain the banknotes conveyance state, such as spacing between banknotes, whether or not there is an angle (namely a skew) of the banknotes with respect to the conveyance direction, and whether or not banknotes are overlapping with each other (what is called double feeding or chains).

Moreover inside the front side conveyance section 21, the classification section 14 is installed such that a distance to the temporary holding switching section 20 is extremely short.

### 2-5. Lower Section Block Configuration

As illustrated in FIG. 2, the lower section block 10L is provided with the reject box 16 for storing banknotes that are unsuitable for re-use, the four individual banknote storage boxes 17 (17A, 17B, 17C, and 17D) for storing reusable banknotes, and with the recovery box 19 for storing banknotes that should be stored other than in the reject box 16 from out of the banknotes that should not be reused.

The reject box 16 is positioned furthest to the front side and toward the top inside the lower section block 10L, is formed in a cuboidal shape that is long in the up-down direction, and includes an internal space in which banknotes are stacked and stored. Note that the length of the reject box 16 in the up-down direction is approximately half that of the lower section block 10L. At the reject box 16, banknotes that the classification section 14 and the banknote control section 11 have determined to have a high level of damage and to be unsuitable for reuse arrive conveyed in by the straight line conveyance section 29, and these banknotes are internally stored in the reject box 16.

The recovery box 19 is provided inside the lower section block 10L at a rear of the reject box 16. The recovery box 19 is formed in a cuboidal shape that is long in the up-down direction, and also includes an internal space for stacking and storing banknotes. From out of the banknotes determined to be unsuitable for reuse, when banknotes that should be stored other than in the reject box 16 arrive conveyed by the straight line conveyance section 29, the recovery box 19 stores these banknotes internally.

At the rear of the recovery box 19 inside the lower section block 10L, the banknote storage boxes 17A, 17B, 17C, and 17D are provided in this sequence from the front side toward the rear side so as to form a row along an array direction thereof, which is the front-rear direction. Each of the banknote storage boxes 17 (17A, 17B, 17C, and 17D) is of a similar configuration, is formed in a cuboidal shape that is long in the up-down direction, and also includes an internal space in which banknotes are stacked and stored. Note that the length of each banknote storage box 17 in the up-down direction is substantially the same as that of the lower section block 10L.

Each of the banknote storage boxes 17 is preset with a denomination of the banknotes to be respectively stored therein. When banknotes determined to have a low level of damage and to be suitable for re-use by the classification section 14 and the banknote control section 11 arrive conveyed in by the straight line conveyance section 29, the banknote storage boxes 17 internally stack and store the banknotes by denomination. On receipt of an instruction from the banknote control section 11 to feed out banknotes, the banknote storage boxes 17 separate and feed out the stacked banknotes one note at a time and transfer them across to the straight line conveyance section 29.

Note that, depending on the control of the banknote control section 11, the banknote storage boxes 17 are also capable of operating as pay-out boxes that only perform feed-out of banknotes stored therein, and of operating as pay-in boxes that only perform storing of banknotes conveyed in.

All the peripheral side faces of the lower section block 10L are covered by a toughened safe case 10S. The safe case 10S is, for example, provided with an openable and closable door at a rear side, and a lock to maintain a closed state (neither of which are illustrated in the drawings). The respective sections inside the lower section block 10L can only be accessed when the lock has been unlocked and the door has been opened.

The straight line conveyance section 29 is positioned above the lower section block 10L, namely outside the safe case 10S. The front side conveyance section 21, the temporary holding switching section 20, and the rear side conveyance section 22 of the straight line conveyance section 29 are accordingly in a row facing from front to rear at the upper side of the safe case 10S, and form a straight line shaped conveyance path along the front-rear direction. An upper face of the safe case 10S is provided with long thin slit-shaped through holes between the straight line conveyance section 29 and the reject box 16, each of the banknote storage boxes 17, and the recovery box 19. The straight line conveyance section 29 enables transfer in the up-down direction of banknotes to and from the reject box 16, each of the respective banknote storage boxes 17, and the recovery box 19 through the through holes of the safe case 10S.

Furthermore, storage box run monitoring sensors 34 for detecting conveyed banknotes are disposed between these through holes and the reject box 16, each of the banknote storage boxes 17, and the recovery box 19 in a cassette transfer section, with this being a location where banknotes are transferred to and from the straight line conveyance section 29, and to and from the reject box 16, each of the banknote storage boxes 17, and the recovery box 19. The storage box run monitoring sensors 34 are configured similarly to the optical sensors provided to the run sensor 33 of the classification section 14, detect a conveyance state of the banknotes, and send detection results thereof to the banknote control section 11. The banknote control section 11 determines whether or not banknotes have been stored in each of the banknote storage boxes 17 based on the detection results supplied from the storage box run monitoring sensors 34.

### 3. Pay-In Processing

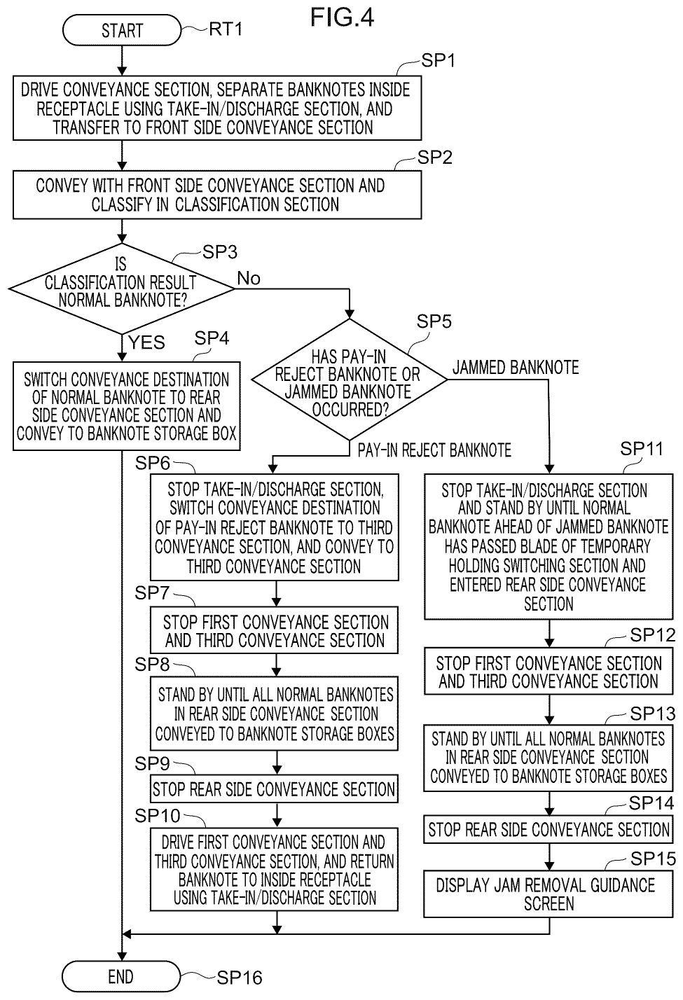

Next, description follows regarding a pay-in processing routine when a customer (user) is paying in banknotes to the automated teller machine 1, with reference to a flowchart illustrated in FIG. 4. In the pay-in processing, the banknote pay-in/pay-out device 10 performs pay-in processing of banknotes by direct pay-in under control of the banknote control section 11.

More specifically, when for example operational input indicating to start pay-in processing has been received from a customer through the operation and display section 6 (FIG. 1), the banknote control section 11 starts a pay-in processing routine RT1 illustrated in FIG. 4 by reading and executing a pay-in processing program from the storage section 11M, and then transitions to step SP1. At step SP1, the banknote control section 11 opens the shutter 12B of the pay-in/pay-out section 12 and lets banknotes be introduced into the receptacle 12A. Next, the banknote control section 11 closes the shutter 12B when an operational input to start taking in banknotes has been received through the operation and display section 6, drives the motor M1 so as to operate the take-in/discharge section 12C in take-in mode, and also drives the conveyance section 13. More specifically, the banknote control section 11 drives the motor M2 so as to cause each of the rollers of the pay-in/pay-out conveyance section 12D, each of the rollers of the front side conveyance section 21, and the rollers 20R1 and the rollers 20R3 of the temporary holding switching section 20 to be rotated, and also drives the motor M3 so as to cause each of the rollers of the rear side conveyance section 22 and the rollers 20R2 of the temporary holding switching section 20 to be rotated. The banknote control section 11 thereby drives the pay-in/pay-out conveyance section 12D, the straight line conveyance section 29, and the third conveyance section 30 so as to drive banknotes from the pay-in/pay-out section 12 in a downstream conveyance direction that is a direction toward the banknote storage boxes 17 or the temporary holding section 15, separates and takes in the banknotes inside the receptacle 12A one note at a time using the take-in/discharge section 12C, sequentially transfers these through the pay-in/pay-out conveyance section 12D positioned downstream thereof to the front side conveyance section 21 of the straight line conveyance section 29, and then transitions to step SP2. When this is performed, the banknote control section 11 switches the temporary holding switching section 20, and forms a conveyance path linking the front side conveyance section 21 and the rear side conveyance section 22 together.

Note that the take-in/discharge section 12C transfers the banknotes to the front side conveyance section 21 of the straight line conveyance section 29 positioned downstream in a state in which the short edges of the banknotes are substantially parallel with the conveyance direction, and the long edges are substantially orthogonal thereto. The take-in/discharge section 12C takes in and feeds out the banknotes at each of a specific time interval so as to separate the banknotes conveyed by the front side conveyance section 21 out to a specific conveyance spacing.

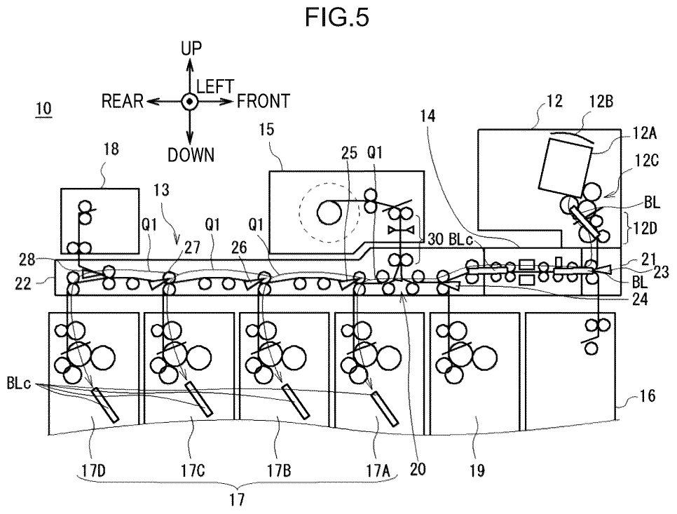

The front side conveyance section 21 switches the reject switching section 23 and forms a conveyance path linking the pay-in/pay-out section 12 and the classification section 14 on the rear side together, and as illustrated by the arrow Q1 in FIG. 5, the banknotes BL are transferred in sequence to the front transfer port on the front side of the downstream classification section 14.

At step SP2, the banknote control section 11 transfers the banknote BL to the classification section 14 as illustrated by arrow Q1, and then transitions to step SP3. Each of the banknotes BL is sequentially classified using the authenticity sensor 31, the image sensor 32, and the run sensor 33 while the banknotes BL are being conveyed toward the rear inside the classification section 14, the banknotes BL are then transferred again to the front side conveyance section 21 from the rear transfer port at the rear side, and also classification results thereof are sent to the banknote control section 11.

Based on the classification results acquired from the classification section 14, the banknote control section 11 first determines the level of damage and denomination, or authenticity of each banknote BL. Next, the banknote control section 11 determines whether each banknote is a pay-in acceptable banknote that can be ascertained to be a normal banknote BL able to continue on to subsequent processing, or a pay-in reject banknote serving as an abnormal banknote that is unable to be ascertained as a normal banknote BL and should therefore be returned to the user. Pay-in reject banknotes are often determined, for example, when banknotes BL are in a folded state, when banknotes BL are heavily creased, or when a piece of paper other than a banknote BL (such as notepaper or a receipt) has been accidentally introduced into the pay-in/pay-out section 12, and banknotes BL for which the banknote BL itself is normal but a skew, for example, has occurred during running are also determined to be pay-in reject banknotes.

The banknote control section 11 decides a final conveyance destination for each of the pay-in acceptable banknotes, namely the reject box 16 for reject banknotes with a high level of damage, the banknote storage box 17 of the respective denomination for normal banknotes that are both normal and reusable banknotes, and the counterfeit note box 18 for counterfeit notes. The banknote control section 11 moreover associates the denomination, serial number, conveyance state (namely skew and the spacing between the banknotes BL), and decided conveyance destination and the like of each banknote BL by associating against a conveyance sequence of the banknotes BL, and stores these in the storage section 11M.

At step SP3, the banknote control section 11 determines whether or not the banknote BL is a normal banknote based on the classification results. The banknote control section 11 transitions to step SP4 when an affirmative result is obtained here. When this occurs, the front side conveyance section 21 uses the first switching section 24 to form a conveyance path linking the short conveyance path at the rear side and the short conveyance path at the front side together, and conveys normal banknotes BLc, transferred in from the rear transfer port of the classification section 14 positioned upstream, toward the rear, and sequentially transfers the normal banknotes BLc to the temporary holding switching section 20 positioned at downstream of the classification section 14.

At step SP4, the banknote control section 11 switches the temporary holding switching section 20 so as to form a conveyance path linking the front side conveyance section 21 and the rear side conveyance section 22 together, switches the conveyance destination of the normal banknote BLc to the rear side conveyance section 22, and as indicated by arrow Q1, forms a conveyance path linking the front side conveyance section 21 and the rear side conveyance section 22 together to cause progression into the rear side conveyance section 22. Then the banknote control section 11 switches the second switching section 25, the third switching section 26, the fourth switching section 27, and the counterfeit note switching section 28 as appropriate, conveys all of the normal banknotes BLc to the banknote storage boxes 17 by denomination and stacks them therein, transitions to step SP16, and ends the pay-in processing routine RT1.

However, when a negative result is obtained at step SP3, this indicates that there is a possibility that a pay-in reject banknote has occurred or that a jammed banknote has occurred, and so the banknote control section 11 transitions to step SP5 in such cases. Based on the classification result, at step SP5 the banknote control section 11 determines whether or not the banknote BL is a pay-in reject banknote, or a jammed banknote has occurred in the process of the banknotes BL being conveyed. When determined that a pay-in reject banknote has occurred, the banknote control section 11 transitions to step SP6.

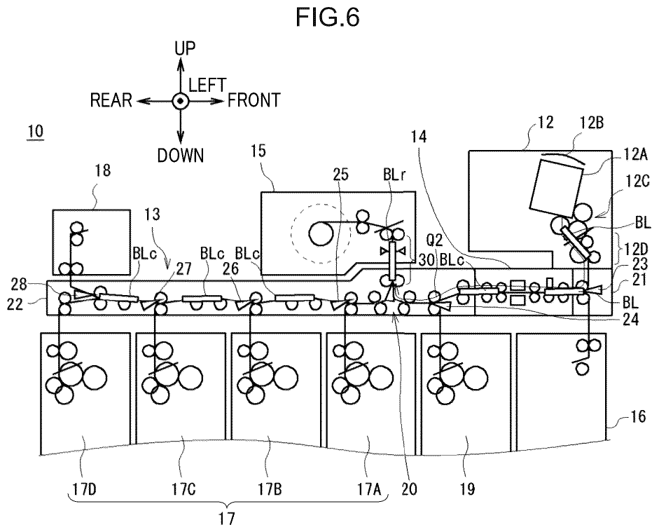

At step SP6, the banknote control section 11 stops the take-in/discharge section 12C by stopping the motor M1, and also switches the conveyance destination of the pay-in reject banknote BLr to the third conveyance section 30 by switching the temporary holding switching section 20 so as to form a conveyance path linking the front side conveyance section 21 and the third conveyance section 30 together, and as indicated by arrow Q2 in FIG. 6, forms a conveyance path linking the front side conveyance section 21 and the third conveyance section 30 together to cause progression into the third conveyance section 30 and conveyance to just in front of the temporary holding section 15, and the processing transitions to step SP7.

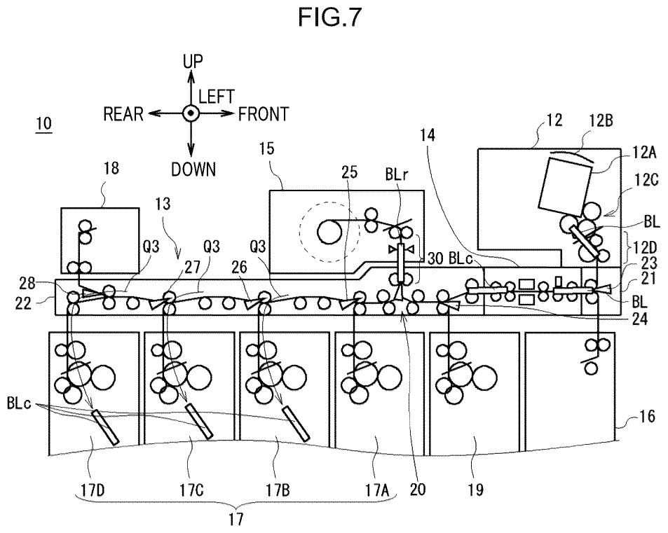

At step SP7, the banknote control section 11 stops each of the rollers of the first conveyance section 35 and the third conveyance section 30 (namely, each of the rollers of the pay-in/pay-out conveyance section 12D, each of the rollers of the front side conveyance section 21, and the rollers 20R 1 and 20R3 of the temporary holding switching section 20) by stopping the motor M2, and transitions to step SP8. When doing so, the banknote control section 11 does not stop driving the motor M3 and conveys the normal banknotes BLc in the rear side conveyance section 22 to the banknote storage boxes 17 by denomination and stacks them therein, as illustrated by the arrows Q3 in FIG. 7.

At step SP8, the banknote control section 11 stands by until all of the normal banknotes BLc in the rear side conveyance section 22 have been conveyed to the banknote storage boxes 17, and transitions to step SP9. At step SP9, the banknote control section 11 stops each of the rollers of the rear side conveyance section 22 by stopping the motor M3, and transitions to step SP10.

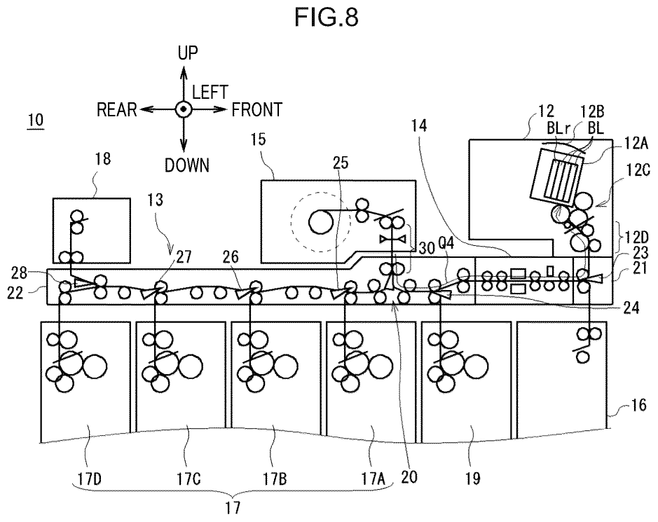

At step SP10, the banknote control section 11 drives the motor M1 so as to operate the take-in/discharge section 12C in discharge mode, and also drives the motor M2 to rotate each of the rollers of the first conveyance section 35 and the third conveyance section 30 (namely, each of the rollers of the pay-in/pay-out conveyance section 12D, each of the rollers of the front side conveyance section 21, and the rollers 20R 1 and 20R3 of the temporary holding switching section 20). Thereby, the banknote control section 11 drives the pay-in/pay-out conveyance section 12D, the front side conveyance section 21, and the third conveyance section 30 in the upstream conveyance direction that is the opposite direction to the downstream conveyance direction, and also by discharging the banknotes BL inside the receptacle 12A using the take-in/discharge section 12C, returns the pay-in reject banknote BLr in the third conveyance section 30, and banknotes BL subsequent to the pay-in reject banknote BLr in the front side conveyance section 21 and the pay-in/pay-out conveyance section 12D, into the receptacle 12A by sending in the opposite direction to that of pay-in processing, as illustrated by arrow Q4 in FIG. 8, transitions to step SP16, and ends the pay-in processing routine RT1.

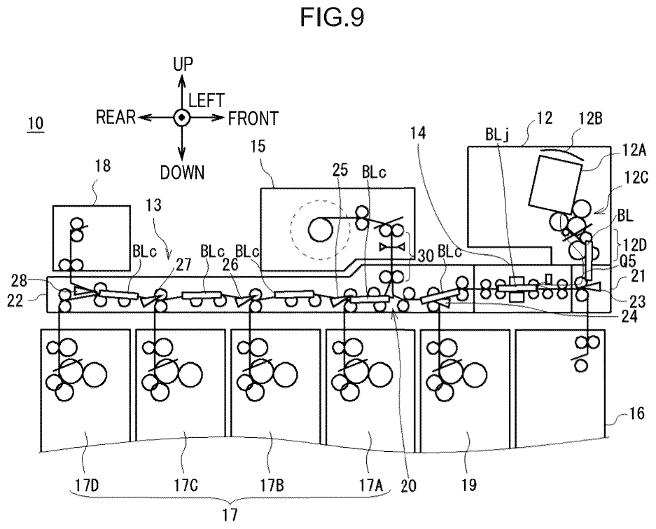

However, the banknote control section 11 transitions to step SP11 at a time when determined at step SP5 that a jammed banknote has occurred. The jammed banknote is a banknote that has become stuck on the conveyance path. In the present exemplary embodiment, consider a case in which, as an abnormal banknote illustrated in FIG. 9, a jammed banknote BLj has occurred not in the rear side conveyance section 22, but in the take-in/discharge section 12C, the pay-in/pay-out conveyance section 12D, the front side conveyance section 21, the temporary holding switching section 20, or the third conveyance section 30. FIG. 9 illustrates a case in which the jammed banknote BLj has occurred in the front side conveyance section 21.

At step SP11, the banknote control section 11 stops the take-in/discharge section 12C by stopping the motor M1 and also, without stopping driving of the motor M2 and the motor M3, stands by until a trailing edge portion of the normal banknote BLc ahead of the jammed banknote BLj has passed the blade 20B of the temporary holding switching section 20 and entered into the rear side conveyance section 22, and transitions to step SP12. In this manner, even though there is a possibility that the jammed banknote BLj itself might become more stuck in the conveyance path, the banknote control section 11 conveys all of the normal banknotes BLc in the front side conveyance section 21 to the rear side conveyance section 22.

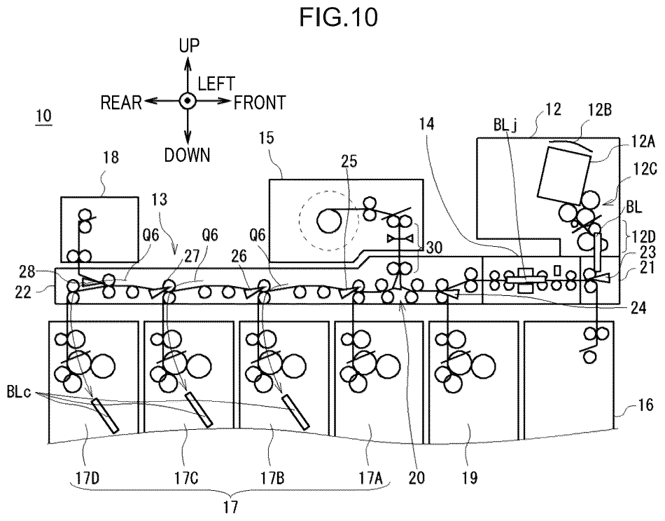

At step SP12, the banknote control section 11 stops each of the rollers of the first conveyance section 35 and the third conveyance section 30 (namely, each of the rollers of the pay-in/pay-out conveyance section 12D, each of the rollers of the front side conveyance section 21, and the rollers 20R1 and 20R3 of the temporary holding switching section 20) by stopping the motor M2, such that the jammed banknote BLj is not conveyed even further, and transitions to step SP13. When doing so, the banknote control section 11 does not stop driving the motor M3, and conveys the normal banknotes BLc in the rear side conveyance section 22 to the banknote storage boxes 17 by denomination and stacks them therein, as illustrated by arrows Q6 in FIG. 10.

At step SP13, the banknote control section 11 stands by until all of the normal banknotes BLc in the rear side conveyance section 22 are conveyed to the banknote storage boxes 17, and transitions to step SP14. At step SP14, the banknote control section 11 stops each of the rollers of the rear side conveyance section 22 by stopping the motor M3, and transitions to step SP15.

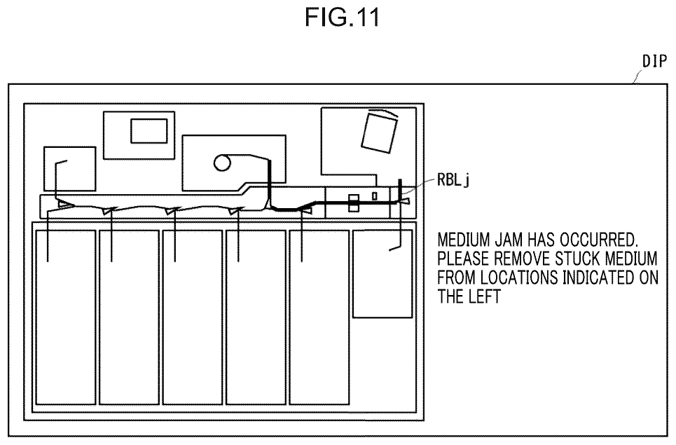

At step SP15, the banknote control section 11 presents removing the jammed banknote BLj from inside the banknote pay-in/pay-out device 10 to an operator by displaying a jam removal guidance screen DIP illustrated in FIG. 11 on the operation and display section 6 (FIG. 1), serving as a guide section, transitions to step SP16, and ends the pay-in processing routine RT1.

In the jam removal guidance screen DIP, jammed banknote removal locations RBLj, which are locations where there is a possibility of a jam occurring, are emphasis displayed in a manner such as a different color or the like to locations other than the jammed banknote removal locations RBLj in the conveyance section 13, as illustrated by the bold lines in FIG. 11. The banknote pay-in/pay-out device 10 displays this jam removal guidance screen DIP after all of the normal banknotes BLc ahead of the jammed banknote BLj have been conveyed to the banknote storage boxes 17 and stacked therein by conveying such that the jammed banknote BLj does not reach the rear side conveyance section 22. Thus at the point in time when the jam removal guidance screen DIP is displayed, the jammed banknote BLj is not present in the rear side conveyance section 22 (and more specifically in a range from the temporary holding switching section 20 to the cassette transfer section). Thus the first conveyance section 35 and the third conveyance section 30 are emphasis displayed in the jam removal guidance screen DIP, and a range between the temporary holding switching section 20 and the cassette transfer section is excluded from the jammed banknote removal locations RBLj and displayed.

### 4. Advantageous Effects Etc.

Hitherto in a pay-in transaction for an automated teller machine in which direct pay-in is not performed, first pay-in counting processing is performed to count the number of banknotes paid in while classifying the denomination and the like thereof, and to hold the banknotes in a temporary holding section prior to confirmation of pay-in, and then next, when pay-in confirmation has been made, pay-in storage processing is performed to convey the banknotes from the temporary holding section to the banknote storage boxes and to store the banknotes therein. This means that when an abnormal banknote, such as a pay-in reject banknote or a jammed banknote has occurred, prior to pay-in confirmation the automated teller machine accumulates the normal banknotes in the temporary holding section, and when an abnormal banknote is a pay-in reject banknote, returns the pay-in reject banknote to the pay-in/pay-out section.

In contrast thereto, for an automated teller machine in which direct pay-in is performed, in a pay-in transaction the banknotes are conveyed to and stored in the banknote storage boxes prior to pay-in confirmation. This means that when an abnormal banknote, such as a pay-in reject banknote or a jammed banknote has occurred, there are normal banknotes present ahead of the abnormal banknote in the conveyance sections between the classification section and the banknote storage boxes. In such a situation, when all of the banknotes on the conveyance section are returned to the pay-in/pay-out section, then normal banknotes and the abnormal banknote will become mixed up, and irrespective of being classified as normal, the normal banknotes will be returned to the pay-in/pay-out section mixed with the abnormal banknote.

Moreover, when an abnormal banknote occurs and the conveyance section has been stopped, banknotes detected by storage box run monitoring sensors are sometimes in a state of entering into the banknote storage box although part thereof is still present in the conveyance section, and these are sometimes counted as already being stored in the banknote storage boxes. This means that in such a situation for cases in which all of the banknotes in the conveyance section have been returned to the pay-in/pay-out section, the banknotes that have been ascertained as already being stored in the banknote storage box are still returned to the pay-in/pay-out section, and there has been a possibility of mis-counting occurring.

In contrast thereto, the banknote pay-in/pay-out device 10 is conveyed such that in cases in which an abnormal banknote has occurred in the front side conveyance section 21 during executing of direct pay-in, the take-in/discharge section 12C, the pay-in/pay-out conveyance section 12D, the front side conveyance section 21, and the third conveyance section 30 are all stopped and, without stopping the second conveyance section, standby is adopted until all of the normal banknotes BLc present in the rear side conveyance section 22 ahead of the abnormal banknote have been stored in the banknote storage boxes 17. This means that the banknote pay-in/pay-out device 10 is configured so as not to cause the normal banknotes BLc to linger in the rear side conveyance section 22 and is able to prevent mixing up of the normal banknotes BLc with the abnormal banknote. In this manner the banknote pay-in/pay-out device 10 is able to prevent normal banknotes BLc from being returned, and is also able to prevent mis-counting and improve reliability.

In the banknote pay-in/pay-out device 10, in order to shorten the time needed until completion of the pay-in processing as much as possible, the banknotes BL are conveyed as fast as possible in the straight line conveyance section 29, and the classification section 14 is installed inside the front side conveyance section 21 such that a distance to the temporary holding switching section 20 is extremely short. This means that in the banknote pay-in/pay-out device 10, from when a banknote BL has been determined to be a pay-in reject banknote BLr, when the front side conveyance section 21 is stopped while still in a state in which the temporary holding switching section 20 forms a conveyance path linking the front side conveyance section 21 and the rear side conveyance section 22 together, the pay-in reject banknote BLr enters as far as the rear side conveyance section 22 without being held in the front side conveyance section 21. Were driving of the rear side conveyance section 22 to continue in such a state then there would be a possibility that the pay-in reject banknote BLr would be stored in the banknote storage boxes 17.

In order to address this, the banknote pay-in/pay-out device 10 is configured so as to switch the temporary holding switching section 20 to a state in which a conveyance path is formed linking the front side conveyance section 21 and the third conveyance section 30 together in cases in which an abnormal banknote is a pay-in reject banknote BLr. The banknote pay-in/pay-out device 10 is thereby able to evacuate the pay-in reject banknote BLr from the front side conveyance section 21 to the third conveyance section 30. The banknote pay-in/pay-out device 10 is thereby able to be configured so as not to let the pay-in reject banknote BLr reach the rear side conveyance section 22 from the front side conveyance section 21 while still increasing the speed of pay-in processing, and so as to ensure that the pay-in reject banknote BLr is not stored in the banknote storage boxes 17.

Furthermore, after standing by until all of the normal banknotes BLc present in the rear side conveyance section 22 have been stored in the banknote storage boxes 17, the banknote pay-in/pay-out device 10 drives the pay-in/pay-out conveyance section 12D, the front side conveyance section 21, and the third conveyance section 30 in the upstream conveyance direction, so as to convey the pay-in reject banknote BLr to the pay-in/pay-out section 12. The banknote pay-in/pay-out device 10 is accordingly able to return the pay-in reject banknote BLr to a customer.

Furthermore, in cases in which the abnormal banknote is a jammed banknote BLj, the banknote pay-in/pay-out device 10 is configured to stand by until the trailing edge portion of the normal banknote BLc ahead of the jammed banknote BLj has passed the blade 20B of the temporary holding switching section 20 and entered the rear side conveyance section 22 before then stopping the pay-in/pay-out conveyance section 12D, the front side conveyance section 21, and the third conveyance section 30. The banknote pay-in/pay-out device 10 is thereafter accordingly able to store all of the normal banknotes BLc that have already finished classification in the banknote storage boxes 17 by continuing to drive the rear side conveyance section 22.

Furthermore, the banknote pay-in/pay-out device 10 is configured so as to display the jam removal guidance screen DIP (FIG. 11) on the operation and display section 6 (FIG. 1). The banknote pay-in/pay-out device 10 is accordingly able to guide an operator to get the operator to remove the jammed banknote BLj from one of the jammed banknote removal locations RBLj.

However in addition thereto, the banknote pay-in/pay-out device 10 of the automated teller machine 1 is configured so as to respectively connect the pay-in/pay-out section 12, the classification section 14, the temporary holding section 15, the reject box 16, the banknote storage boxes 17, and the counterfeit note box 18 to the straight line conveyance section 29 formed in a straight line shape along the front-rear direction.

From another perspective, the banknote pay-in/pay-out device 10 is configured such that a straight line shaped conveyance path is formed by the straight line conveyance section 29 so as to pass through the classification section 14, and the pay-in/pay-out section 12 and the reject box 16 are disposed on the conveyance path on one side (for example the front side) of the classification section 14, with the temporary holding section 15 and the banknote storage boxes 17 respectively disposed on the conveyance path on the other side (for example the rear side). To put this another way, in the banknote pay-in/pay-out device 10, conveyance paths having one, or two or more, switching sections connected in series are respectively connected to both ends of a conveyance path passing through the classification section 14.

From yet another perspective, the banknote pay-in/pay-out device 10 is configured such that the temporary holding switching section 20 switches to connect any two conveyance paths together out of a conveyance path toward the pay-in/pay-out section 12, a conveyance path toward the banknote storage boxes 17, and a conveyance path toward the temporary holding section 15. In addition, in the banknote pay-in/pay-out device 10, the classification section 14 is disposed on the conveyance path toward the pay-in/pay-out section 12, and as viewed from the classification section 14, the reject box 16 is connected to the conveyance path on the pay-in/pay-out section 12 side through the reject switching section 23.

Accordingly, in the banknote pay-in/pay-out device 10, the conveyance path of the straight line conveyance section 29 is configured in a straight line shape rather than a loop shape, thereby enabling a simpler configuration than in a banknote pay-in/pay-out device hitherto, enabling a reduction in size and a reduction in the number of components, and also enabling an accompanying reduction to be achieved in the frequency of breakdowns and a reduction to be achieved in the amount of maintenance work and the like.

Due to the above configuration, the banknote pay-in/pay-out device 10 of the automated teller machine 1 is configured so as to be provided with the pay-in/pay-out section 12 into which banknotes BL are introduced as a medium, the take-in/discharge section 12C driven by the motor M1 serving as a first drive source and feeding out the banknotes BL from the pay-in/pay-out section 12, provided with the first conveyance section 35 connected to the pay-in/pay-out section 12 and driven so as to convey the banknotes BL by the motor M2 serving as a second drive source driven independently to the motor M1, the classification section 14 for classifying the conveyed banknotes BL and provided to the first conveyance section 35, provided with the rear side conveyance section 22 connected to the first conveyance section 35 for conveying the banknotes BL and driven by the motor M3 serving as a third drive source driven independently to the motors M1 and M2, provided with the banknote storage boxes 17 for storing the normal banknotes BLc and connected to the rear side conveyance section 22, and provided with the banknote control section 11. When determined that there is a pay-in reject banknote BLr or a jammed banknote BLj that is an abnormal banknote serving as an abnormal medium present in the first conveyance section 35, the banknote control section 11 stops driving of the motor M1 so as to stop the take-in/discharge section 12C and also stops driving the motor M2 so as to stop the first conveyance section 35, and conveys and normal banknotes BLc present in the rear side conveyance section 22 to the banknote storage box 17 stores them therein.

The banknote pay-in/pay-out device 10 is accordingly configured such that the normal banknotes BLc are not caused to linger in the rear side conveyance section 22, enabling the normal banknotes BLc in the conveyance section 13 to be prevented from mixing with the abnormal banknote.

### 5. Other Exemplary Embodiments

Note that in the exemplary embodiment described above a case has been described in which each of the rollers of the pay-in/pay-out conveyance section 12D, each of the rollers of the front side conveyance section 21, and the rollers 20R1 and 20R3 of the temporary holding switching section 20 are driven by the motor M2. However, the present disclosure is not limited thereto and, for example, each of the rollers of the pay-in/pay-out conveyance section 12D, each of the rollers of the front side conveyance section 21, and the rollers 20R1 of the temporary holding switching section 20 may be driven by the motor M2, and the rollers 20R3 of the temporary holding switching section 20 may be driven by a different motor to the motor M2. In other words, a configuration in which at least the drive source to drive the take-in/discharge section 12C, the drive source to drive the front side conveyance section 21, and the drive source to drive the rear side conveyance section 22 are driven independently from each other is sufficient.

In the exemplary embodiment described above a case was described in which the pay-in reject banknote BLr was evacuated from the front side conveyance section 21 to the third conveyance section 30. However, the present disclosure is not limited thereto, and although this might possibly make the front-rear length of the banknote pay-in/pay-out device 10 longer, in cases in which the front-rear length of a portion of the front side conveyance section 21 at the rear of the classification section 14 is stretched and the spacing between the classification section 14 and the rear side conveyance section 22 has been widened to such an extent that a pay-in reject banknote BLr in the front side conveyance section 21 does not reach the rear side conveyance section 22 when the motor M2 has been stopped so as to stop the front side conveyance section 21, the pay-in reject banknote BLr may be held in the front side conveyance section 21 and not evacuated from the front side conveyance section 21 to the third conveyance section 30.

Furthermore, in the exemplary embodiment described above a case has been described in which the attachment positions of the motors M1, M2, and M3 are in the vicinity of each of the rollers etc. to which the respective drive force is to be transmitted, namely inside the take-in/discharge section 12C, the front side conveyance section 21, and the rear side conveyance section 22. However, the present disclosure is not limited thereto and, for example, the motor M2 may be disposed at a freely selected position such as inside the front side conveyance section 21, outside the straight line conveyance section 29, or the like and drive force from the motor M2 may be transmitted to each of the rollers etc. inside the rear side conveyance section 22 through non-illustrated gears or the like. Furthermore, for example, by omitting the motors M2 and M3 and also utilizing an appropriate combination of a non-illustrated clutch mechanism, gears having different numbers of teeth, and the like, conveyance of the banknotes BL in the front side conveyance section 21 and in the rear side conveyance section 22 may be controlled independently by respectively transmitting the drive force from the motor M1 to the rollers in the front side conveyance section 21 and to the rollers in the rear side conveyance section 22.

Furthermore, in the exemplary embodiment described above a case has been described in which the jam removal guidance screen DIP (FIG. 11) is displayed on the operation and display section 6 (FIG. 1), and an operator is guided to get the operator to remove the jammed banknote BLj from one of the jammed banknote removal locations RBLj. However, the present disclosure is not limited thereto, and a location where the jammed banknote BLj is present may, for example, be guided by voice, may be guided using LED or the like provided inside the case 2, or may be guided by various other guide sections.

Furthermore, in the exemplary embodiment described above a case has been described in which the run sensor 33 is configured by the thickness sensor and the optical sensors, and whether or not there is double feeding in the banknote control section 11, skew of each of the banknotes BL, and a spacing between each of the banknotes BL is ascertained based on respective detection results. However, the present disclosure is not limited thereto and a configuration may be adopted with run sensors using various other sensors. In other words in the pay-in processing it is sufficient to be able to detect whether or not each of the banknotes BL is a pay-in reject banknote.

Furthermore, in the exemplary embodiment described above a case has been described in which the temporary holding switching section 20 that switches the conveyance path so as to convey the pay-in reject banknote BLr from the straight line conveyance section 29 to the temporary holding section 15 is disposed between the first switching section 24 and the second switching section 25, and the straight line conveyance section 29 is split into the front side conveyance section 21 at the front side and the rear side conveyance section 22 at the rear side by the temporary holding switching section 20. However, the present disclosure is not limited thereto, and the temporary holding switching section 20 may be disposed at another location inside the straight line conveyance section 29.

Furthermore, in the exemplary embodiment described above a case has been described in which the straight line conveyance section 29 is configured so as to be broadly divided into the front side conveyance section 21, the temporary holding switching section 20, and the rear side conveyance section 22. However, the present disclosure is not limited thereto and, for example, the straight line conveyance section 29 may be multi-divided in various ways, or there may be a single individual straight line conveyance section 29 without being divided. However, preferably at least the rollers of the take-in/discharge section 12C for taking in the banknotes BL from the pay-in/pay-out section 12 or discharging thereto, the rollers for conveying the banknotes BL at the front side of the temporary holding switching section 20, and the rollers for conveying the banknotes BL at the rear side of the temporary holding switching section 20, are able to be driven independently. The conveyance section 13 is thereby able, when an abnormal banknote has occurred, to convey the normal banknotes BLc from the rear side conveyance section 22 to the banknote storage box 17 in a state in which the abnormal banknote is held in the front side conveyance section 21 or the third conveyance section 30.

Furthermore, in the above exemplary embodiment a case has been described in which there are three types of sensor provided in the classification section 14, these being the authenticity sensor 31, the image sensor 32, and the run sensor 33. However, the present disclosure is not limited thereto, and two types of sensor or fewer may be provided in the classification section 14, or four types of sensor or more may be provided. Moreover, various sensors may be provided in the front side conveyance section 21 and not in the classification section 14, and pay-in reject banknotes and jammed banknotes discriminated by the banknote control section 11. In other words, based on the detection results obtained, it is sufficient for the banknote control section 11 to be able to at least determine in the pay-in processing whether or not each of the banknotes is a normal banknote, or an pay-in reject banknote, and to be able to determine the conveyance destination thereof.

Furthermore in the exemplary embodiment described above a case has been described in which there are four individual banknote storage boxes 17 (17A to 17D) provided in the banknote pay-in/pay-out device 10. However, the present disclosure is not limited thereto, and three individual banknote storage boxes 17 or less, or five individual banknote storage boxes 17 or more, may be provided. For example, in cases in which there are three individual banknote storage boxes 17 provided, the front-rear length of the automated teller machine 1 can be greatly truncated, which is suitable for cases in which installation is at a place where the installation footprint is limited, such as in a convenience store.

Furthermore, in the exemplary embodiment described above a case has been described in which the detection results of each of the sensors of the classification section 14 are sent to the banknote control section 11 such that the conveyance destination is decided by the banknote control section 11 after ascertaining the denomination, the authenticity, the level of damage, and the like of the banknote BL. The present disclosure is not limited thereto and, for example, a dedicated classification control section may be provided in the classification section 14 and the detection results of each of the sensors of the classification section 14 sent to this classification control section, so that the denomination, the authenticity, the level of damage, and the like of the banknote BL are ascertained in this classification control section. In such cases, information representing the denomination, the authenticity, the level of damage, and the like as ascertained in the classification control section may be sent to the banknote control section 11 such that the conveyance destination of the banknote BL is decided in the banknote control section 11. This thereby enables the processing load of the banknote control section 11 to be reduced.

Furthermore, in the exemplary embodiment described above a case has been described in which various processing such as the pay-in processing is executed in the banknote control section 11 of the banknote pay-in/pay-out device 10. However, the present disclosure is not limited thereto and, for example, each of the processing may be executed by a main control section 9 (FIG. 1) of the automated teller machine 1, or by cooperation between this main control section 9 and the banknote control section 11.

Furthermore, in the exemplary embodiment described above a case has been described in which the present disclosure is applied to the banknote pay-in/pay-out device 10 of the automated teller machine 1 that performs transaction processing related to banknotes with a customer. However the present disclosure is not limited thereto and, for example, the present disclosure may be applied to a dedicated pay-in machine utilized in a backroom of a store, to various devices that handle cash such as a cash processing device or the like utilized by bank employees either in a back office or adjacent to a service window, or to various devices that handle various paper leaf-shaped media such as various types of cash vouchers and securities or the like, or entrance tickets and travel tickets.

Furthermore, the present disclosure is not limited to each of the exemplary embodiments described above or to the other exemplary embodiments. Namely, an applicable range of the present disclosure encompasses exemplary embodiments resulting from freely combining each of the exemplary embodiments described above with part or all of the other exemplary embodiments described above. Moreover for the present disclosure, an applicable range of the present disclosure also encompasses cases in which part of a configuration described in a freely selected exemplary embodiment from out of the exemplary embodiments described above and the other exemplary embodiments described above has been extracted and swapped over or employed for part of configuration of a freely selected exemplary embodiment from out of the exemplary embodiments described above and the other exemplary embodiments described above, and cases in which the extracted part of the configuration has been added to a freely selected exemplary embodiment.

Furthermore, in the exemplary embodiment described above a case has been described in which the banknote pay-in/pay-out device 10 serving as a medium processing device and the automated teller machine 1 serving as a medium transaction device have been configured by the pay-in/pay-out section 12 serving as an pay-in section, the take-in/discharge section 12C serving as a feed-out section, the first conveyance section 35 serving as a first conveyance section, the classification section 14 serving as a classification section, the rear side conveyance section 22 serving as a second conveyance section, the banknote storage boxes 17 serving as storage boxes, and the banknote control section 11 serving as a control section. However, the present disclosure is not limited thereto, and the medium processing device and the medium transaction device may be configured by a pay-in section, a feed-out section, a first conveyance section, a classification section, a second conveyance section, a storage box, and a control section of various other configurations.

### INDUSTRIAL APPLICABILITY

The present disclosure may also be utilized for an automated teller machine or the like that performs transaction processing related to pay-in/pay-out of banknotes with a customer.

The disclosure of Japanese Patent Application No. 2021-099779 is incorporated in its entirety by reference herein.

All cited documents, patent applications and technical standards mentioned in the present specification are incorporated by reference in the present specification to the same extent as if the individual cited document, patent application, or technical standard was specifically and individually indicated to be incorporated by reference.

1. A medium processing device comprising:
a pay-in section into which a medium is introduced;
a feed-out section that is driven by a first drive source so as to feed out the medium from the pay-in section;
a first conveyance section that is connected to the pay-in section and driven by a second drive source driven independently of the first drive source so as to convey the medium;
a classification section that is provided to the first conveyance section and classifies the conveyed medium;
a second conveyance section that is connected to the first conveyance section, and driven by a third drive source for driving independently of the first drive source and the second drive source so as to convey the medium;
a storage box that is connected to the second conveyance section and stores the medium; and
a control section that, when determined that an abnormal medium is present in the first conveyance section, stops driving of the first drive source so as to stop the feed-out section and also stops driving of the second drive source so as to stop the first conveyance section, and conveys the medium present in the second conveyance section to the storage box and stores the medium therein.

2. The medium processing device of claim 1, wherein:
in cases in which the abnormal medium has been determined to be a reject medium that should be returned to a user based on a classification result of the classification section, the control section stores the medium present in the second conveyance section in the storage box before then conveying the reject medium using the first conveyance section so as to return the reject medium to the pay-in section.

3. The medium processing device of claim 1, further comprising:
a guide section that presents specific information to a user of the medium processing device, wherein,
in cases in which the abnormal medium is a jammed medium stuck in the first conveyance section, the control section stores the medium present in the second conveyance section in the storage box before then presenting guidance with the guide section to remove the jammed medium.

4. The medium processing device of claim 3, wherein the control section displays on the guide section a jammed medium removal screen emphasis displaying a portion indicating the first conveyance section as a place where the jammed medium is present.

5. The medium processing device of claim 1, wherein the control section stops conveyance of the abnormal medium without causing the abnormal medium to reach the second conveyance section when the abnormal medium has been determined to be present in the first conveyance section and the first conveyance section has been stopped.

6. The medium processing device of claim 5, further comprising:
a third conveyance section that is connected to the classification section in the first conveyance section at an opposite side to the pay-in section side and that temporarily holds the abnormal medium, wherein,
the control section conveys the abnormal medium to the third conveyance section when determined that the abnormal medium is present in the first conveyance section.

7. The medium processing device of claim 5, wherein:
the second conveyance section is connected to the first conveyance section at a position where the abnormal medium in the first conveyance section does not reach the second conveyance section when driving of the second drive source has been stopped and the first conveyance section has been stopped.

8. The medium processing device of claim 1, wherein:
a plurality of the storage boxes are provided; and
the first conveyance section and the second conveyance section form a conveyance path for the medium having a substantially straight line shape along an array direction in which the plurality of storage boxes have been arrayed.

9. The medium processing device of claim 1, wherein:
the control section conveys a normal medium, which in pay-in processing has been introduced to the pay-in section and determined to be normal based on a classification result of the classification section, by conveying directly without temporary holding to the storage box using the second conveyance section.

10. A medium transaction device comprising:
a pay-in section into which a paper leaf-shaped medium for transaction with a user is introduced;
a feed-out section that is driven by a first drive source so as to feed out the medium from the pay-in section;
a first conveyance section that is connected to the pay-in section and driven by a second drive source driven independently of the first drive source so as to convey the medium;
a classification section that is provided to the first conveyance section and classifies the conveyed medium;
a second conveyance section that is connected to the first conveyance section, and driven by a third drive source for driving independently of the first drive source and the second drive source so as to convey the medium;
a storage box that is connected to the second conveyance section and stores the medium; and
a control section that, when determined that an abnormal medium is present in the first conveyance section, stops driving of the first drive source so as to stop the feed-out section and also stops driving of the second drive source so as to stop the first conveyance section, and conveys the medium present in the second conveyance section to the storage box and stores the medium therein.
